(19) United States
(12) Patent Application Publication
(10) Pub. No.: US 2026/0079269 A1
(43) Pub. Date: Mar. 19, 2026

(54) Particle Alpha Radiation Sampler

(71) Applicant: President and Fellows of Harvard College, Cambridge, MA (US)

(72) Inventors: Petros Koutrakis, Boston, MA (US); Joy E. Lawrence, Framingham, MA (US); Stephen T. Ferguson, Hampstead, NH (US); Carolina L.Z. Vieira, Cambridge, MA (US)

(21) Appl. No.: 19/109,166

(22) PCT Filed: Sep. 7, 2023
(86) PCT No.: PCT/US23/73598

§ 371 Date: Mar. 6, 2025

Related U.S. Application Data
(60) Provisional application No. 63/405,542, filed on Sep. 12, 2022.

(51) Int. Cl. G01T 1/16; G01T 1/00; G01T 1/18

(52) U.S. Cl. CPC G01T 1/1603; G01T 1/003; G01T 1/18

(57) ABSTRACT

A particle alpha radiation sampler includes a scintillation cell, a Geiger counter for measuring the incidence of particle alpha radiation on the scintillation cell, a vessel defining a chamber, at least one inertial impactor, a filter, and a vacuum pump. The scintillation cell is configured to receive alpha radiation passing through air in the chamber from particulate matter collected on the filter. The inertial impactor is configured to allow passage of particles only at or below an established size threshold into the chamber. The filter is configured to collect particulate matter from the air in the chamber drawn through the inertial impactor. Finally, the vacuum pump is configured to draw air flow through the filter from the chamber and to draw air flow through the inertial impactor into the chamber.

### BACKGROUND

The discussion of the background state of the art below may reflect hindsight gained from the disclosed invention(s), and these characterizations are not necessarily admitted to be prior art.

Particle radioactivity (PR) is an intrinsic property of ambient particulate matter (PM). In the same way that particulate matter can be characterized by its mass concentration, size distribution, and other physical and chemical properties, it can also be characterized by its radioactivity. In the absence of anthropogenic release, particle radioactivity predominantly originates from radionuclides of terrestrial origin, particularly radon decay products. Radon is a noble gas, a decay product of ²³⁸U and ²³²Th, both of which are naturally occurring radioactive elements found in the earth's crust. After formation, radon diffuses from the soil into ambient air; and radon can accumulate to higher concentrations indoors in basements and in other underground spaces.

Radon gas decays (with a half-life of 3.8 days) into radionuclides that emit alpha, beta, and gamma radiation. Radon's initial decay products are short-lived radionuclides (with a half-life of seconds to minutes) that continue to decay into long-lived radionuclides (with a half-life of months to years). The initial decay products rapidly form ultrafine clusters that attach to surfaces, including the accumulation mode of ambient particles. This accumulation occurs both indoors and outdoors. These particles can be inhaled and can deposit in the lungs, with potential systemic transport. Once in the body, these radionuclides continue to decay, wherein alpha-emitting radionuclides cause more biological damage than either beta- or gamma-emitting radionuclides due to the large mass and positive charge of the alpha particle.

In a recent pilot study of occupied homes in the greater Boston metropolitan area [Kang, C. M., et al., “Indoor Particle Alpha Radioactivity Origins in Occupied Homes,” 20 Aerosol Air Qual. Res. 1374-1383 (2020)], indoor measurements of particle radioactivity, including alpha activity from both short- and long-lived alpha-emitting radionuclides (SLA and LLA, respectively), found that the concentration of SLA and LLA, like the concentration of radon, are higher in basements than upstairs. Findings from the study suggest that particle radioactivity in homes originates from both the decay of radon (and its short-lived progeny) indoors and the infiltration of outdoor particle radioactivity. SLA was associated with indoor radon decay and, to a lesser extent, with outdoor particle radioactivity, whereas LLA was predominantly related to outdoor particle radioactivity. Additionally, on average, indoor SLA concentrations were approximately four orders of magnitude higher than those of LLA.

Currently available data on ambient particle alpha radioactivity (i.e., the gross alpha activity of ambient particle matter) are insufficient to allow epidemiological studies of the health effects in populations at environmentally relevant exposure levels. However, it is well known that alpha activity causes DNA damage at the cellular level. Additionally, exposure to alpha emitters at low dosage levels causes significantly more chromosome damage in cells than either beta or gamma radiation. Further, alpha activity exposure from ²¹⁰Po associated with cigarette smoking may be a significant contributing factor in the development of human lung cancer.

Recent epidemiological studies, conducted by our team, have shown associations between a variety of human health effects and ambient particle radioactivity measured as gross beta- and gamma-activities. These health effects include association with total and cardiovascular mortality, effects on blood pressure, oxidative stress, and lung and cardiac function. Furthermore, several recent epidemiological studies of non-cancer health effects of radon exposure, conducted by our team, have found significant associations between radon and all-cause mortality and hypertensive disorders of pregnancy. Because radon is a gas, which is mostly inhaled and exhaled, whereas its particle-attached progeny deposit onto lung airways, these associations are likely due to particle radioactivity, specifically with short-lived alpha-emitting radionuclides (SLA) derived from the decay of radon and its progeny.

In our previous study [Kang, C. M., et al., “Indoor Particle Alpha Radioactivity Origins in Occupied Homes,” 20 Aerosol Air Qual. Res. 1374-1383 (2020)], SLA activity was measured using an electret-radon progeny integrating sampling unit (E-RPISU; Rad Elec Inc., Frederick, Maryland, USA). The E-RPISU is an active sampler that provides an integrated, time-weighted average of particle alpha activity. It collects radon progeny on a glass fiber mounted on the side of an electret ion chamber. Alpha particles emitted from the collected progeny ionize the air inside the chamber, and these ions cause the electret voltage to drop. This voltage drop is proportional to the time-integrated progeny concentration. Integrated concentrations of SLA are determined by correcting the total alpha activity (Radon+SLA) for the contribution of Radon decay, measured using a collocated electret-based passive environmental radon/radiation monitor (E-PERM) measurement.

The E-RPISU is only suitable for integrated samples with durations of 2-10 days and cannot measure particle alpha activity continuously. There are some commercially available monitors for ambient alpha activity, such as the Ludlum Model 334A alpha air monitor or the Canberra iCAM alpha beta continuous air monitor. These monitors, however, are mostly designed for workplace monitoring or ambient measurements in emergency response situations and are not considered to be suitable for routine environmental measurement.

Kronenberg, et al., “Instrument for measuring total alpha particle energies of alpha emitters in ambient air,” 454 Nuclear Instruments and Methods in Physics Research A 2000, 520-527 (2000) reported the design, fabrication, testing, and evaluation of a self-reading, carbon-fiber, electrometer-type instrument, used for measuring the total energy of alpha particles emitted in air by radon decay products. However, this device was used for analyzing particulate matter collected separately on a filter and did not sample ambient particulate matter and, thus, is not considered to be suitable for continuous measurement.

Measuring the alpha emissions from long-lived nuclides attached to particles at environmentally relevant levels is relatively easy. Measuring the alpha emissions from the short-lived radionuclides is much more difficult. Because some alpha-emitting radon-decay progeny are so short-lived, collecting and counting these particles is not straightforward.

Investigation of the health effects of environmental exposures to particle radioactivity, specifically particle alpha activity, is a relatively novel field of study. Very little information is available about particle alpha activity exposures, especially because these are dominated by the short-lived radionuclides, which are difficult to measure. Very little is known about the relative effects of peak compared to average exposures. We developed a particle alpha radiation sampler (PARS) to provide a sensitive, reliable, and inexpensive method for time-resolved measurement of alpha activity associated with ambient particulate matter, including SLA, at environmentally relevant concentrations. Described below is the design and validation of exemplifications of such a continuous particle alpha radioactivity sampler.

### SUMMARY

A particle alpha radiation sampler that can operate continuously to measure the gross alpha activity of ambient particle matter and methods of its operation are described herein, where various embodiments of the apparatus and methods may include some or all of the elements, features, and steps described below.

Exemplifications of the particle alpha radiation sampler include a scintillation cell; a Geiger counter in electrical communication with the scintillation cell and configured to measure the incidence of particle alpha radiation on the scintillation cell; a vessel defining a chamber, wherein the scintillation cell is configured to receive alpha radiation passing through air in the chamber from particulate matter collected on a filter; at least one inertial impactor in fluid communication with the chamber and configured to allow passage of particles only at or below an established size threshold into the chamber; the filter, wherein the filter is in fluid communication with the chamber, and wherein the filter is configured to collect particulate matter from the air in the chamber drawn through the inertial impactor; and a vacuum pump in fluid communication with the chamber and configured to draw air flow through the filter from the chamber and to draw air flow through the inertial impactor into the chamber.

In a method for particle alpha radiation sampling, a vacuum pump is used to draw air out of a chamber defined by a vessel and to draw air samples through at least one inertial impactor into the chamber and through a filter. The inertial impactor removes particulate matter sized above an established size threshold, and the filter collects the particulate matter sized below the established size threshold of the inertial impactor. The incidence of alpha radiation on a scintillation cell is recorded, wherein the alpha particles are (i) emitted by radionuclides contained in the particle matter collected on the filter and (ii) travel through the chamber and through a window to a scintillation cell. A signal is transmitted from the scintillation cell to a Geiger counter with each incidence of alpha radiation on the scintillation cell, and the Geiger counter is used to measure the incidence of the alpha radiation on the scintillation cell.

### BRIEF DESCRIPTION OF THE DRAWINGS

FIG. 1 is a partially schematic illustration of a particle alpha radioactivity sampler 10, which can have dimensions of about, e.g., 12 inches×12 inches×12 inches. The particle alpha radioactivity sampler 10 includes a vacuum pump 12 in fluid communication through a particulate filter 14 with a chamber 16 defined in a sampling assembly 15, wherein a metering valve 18 regulates the vacuum applied through the filter 14. The sampling assembly 15 is also configured for inlet air flow from an inlet tube 20 into the chamber 16 through one or more PM_{2.5} inertial impactors 22 configured to collect and remove particular matter over a specified size threshold. A scintillation cell 24 is separated from the chamber 16 by a thin-film window 26 that allows passage of particle alpha radiation therethrough. A Geiger counter 28 is electrically coupled with the scintillation cell 24 to detect the reaction of the scintillation cell 24 to incident particle alpha radiation.

FIG. 2 is a plot comparing 15-minute average alpha concentrations measured by two prototype particle alpha radiation samplers (PARS 1 and PARS-2, represented on the y- and x-axes, respectively), which show excellent agreement during collocated operation. The dotted line in this Figure and others represents a linear fit.

FIG. 3 is a plot comparing hourly (60 minute) average alpha concentrations as measured by two collocated prototype particle alpha radiation samplers.

FIG. 4 is a plot of the alpha decay rate measured by a particle alpha radiation sampler, where the decay rate is determined by regressing the ln(alpha) on elapsed time.

FIG. 5 is a plot of alpha concentrations measured during a prolonged (24 hour) power outage (i.e., with the power out and the pump off starting at 6:55 am on July 4 and lasting through July 5), wherein approximately one-hour time increments are indicated along the x-axis.

FIG. 6 is a plot of alpha concentrations for two collocated particle alpha radiation samplers (PARS1 and PARS2), one measuring continuously and the other with the pump cycling off for one hour out of every four hours, wherein approximately two-hour time increments are indicated along the x-axis.

FIG. 7 plots hourly short-lived alpha-emitting radionuclide activity measurements conducted indoors (on an upstairs floor 34 and in the basement 36 of a house) and outdoors 38.

FIG. 8 is a plot comparing hourly short-lived alpha-emitting radionuclide activity measurements in a basement (x-axis) and upstairs (y-axis) in the main living area of a house during the summer.

FIG. 9 is a plot comparing hourly short-lived alpha-emitting radionuclide activity measurements by a particle activity radiation sampler outdoors (x-axis) and upstairs (y-axis) in the main living area during the summer.

FIG. 10 is a plot showing the relationship along the x- and y-axes, respectively, between measurements of short-lived alpha-emitting radionuclide activity by a particle activity radiation sampler outdoors and upstairs in the main living area during the autumn.

FIG. 11 is a plot of average short-lived alpha activity measured by a particle activity radiation sampler (y-axis) compared to integrated E-RPISU SLA measurement (x-axis). The plots include both the gross working limit (WL) 40 and the net working limit (WL) 42.

In the accompanying drawings, like reference characters refer to the same or similar parts throughout the different views; and apostrophes are used to differentiate multiple instances of the same item or different embodiments of items sharing the same reference numeral. The drawings are not necessarily to scale; instead, an emphasis is placed on illustrating particular principles in the exemplifications discussed below. For any drawings that include text (words, reference characters, and/or numbers), alternative versions of the drawings without the text are to be understood as being part of this disclosure; and formal replacement drawings without such text may be substituted therefor.

### DETAILED DESCRIPTION

The foregoing and other features and advantages of various aspects of the invention(s) will be apparent from the following more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used, or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures, and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly. The term, “about,” can mean within ±10% of the value recited. In addition, where a range of values is provided, each subrange and each individual value between the upper and lower ends of the range is contemplated and, therefore, disclosed.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to limit the broader scope of the invention to particular embodiments. As used herein, singular forms, such as those introduced with the articles, “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video or audio form) for assembly and/or modification by a customer to produce a finished product.

### Apparatus and Methods:

### Particle Alpha Radiation Sampler:

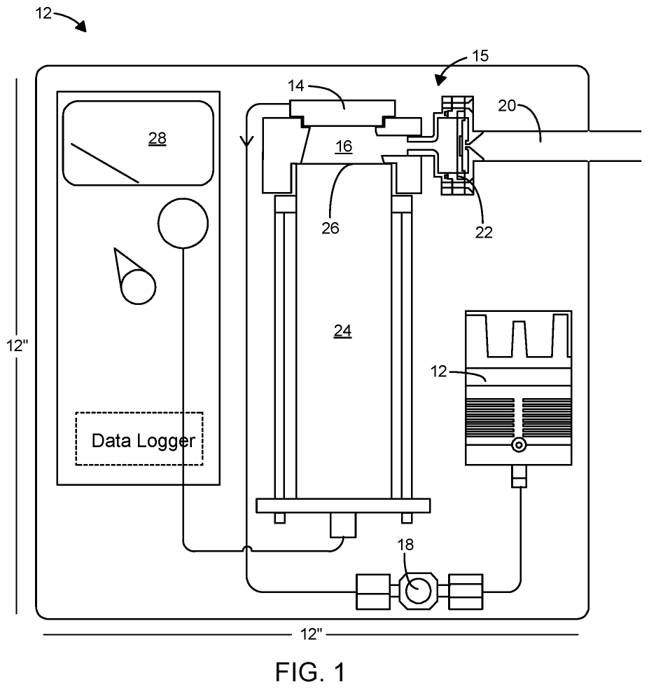

Continuous particle alpha activity was measured in this study using prototype particle alpha radiation samplers 10, an exemplification of which is shown schematically in FIG. 1. We used a custom-made assembly, including one or two inertial impactors 22, which separate particles from a gas stream according to their mass/size, wherein the inertial impactors 22 operate by suddenly changing the direction of a particle-laden gas stream. The heavier and/or larger particles continue to follow a relatively straight trajectory and impact an impaction surface, while lighter/smaller particles substantially follow the gas stream and pass through the inertial impactor 22.

In this case, the inertial impactors are designed to provide a PM_{2.5} size cut at a flow of 1.8 LPM each, where PM_{2.5} represents the fine inhalable particles with diameters of 2.5 μm or smaller, where the flow through the inertial impactors 22 into a chamber 16 defined in the sampling assembly 15 is driven by a vacuum pump 12 with a metering valve 18, which are also in fluid communication with the chamber 16 through a particulate filter 14. The particle alpha radioactivity sampler 10 can be operated using either one or two inlets 20 (with a total flow of 1.8 or 3.6 LPM, respectively) in fluid communication with the inertial impactors 22. The inlet(s) can be in the form of an inlet tube 20 in communication with an environment (e.g., a basement) from which the air is to be sampled.

The particulate filter 14 used to collect particulate matter at or above the size threshold from air flow extracted from the chamber, in this case, was a 37-mm polytetrafluoroethylene (TEFLON fluoropolymer) membrane filter (Pall Corp., Westborough, MA, TEFLO 37-mm filter, Cat. No. RP2PJ037). The particulate filter 14 was mounted parallel to the thin-film window 26 (in this case, in the form of an aluminized polyester film) of the scintillation cell 24, with a 1.2-cm distance between the particulate filter 14 and the thin-film window 26 through which alpha radiation from the particulate matter trapped on/in the particulate filter 14 can pass through the chamber 16 and into contact with the scintillation cell 24. The distance between the particulate filter 14 and the window 26 of the scintillation cell 24 was kept as small as possible to maximize the detection of alpha particles that have a range of approximately 4 cm in air at an energy level of 5.5 MeV.

The scintillation cell 24 can be a ZnS (Ag) alpha detector scintillation cell 24 (model 43-2, Ludlum Measurements Inc., Sweetwater, Texas, USA). The scintillation cell 24 is electrically connected with a Geiger counter 28 (a Model 3 general purpose survey meter from Ludlum Measurements Inc., Sweetwater, Texas, USA) such that an electrical signal is transmitted from the scintillation cell 24 to the Geiger counter 28 with each alpha particle impact on the scintillation cell 24. Both the scintillation cell 24 and the Geiger counter 28 have a functional temperature range of −20 to 50° C. and are thus suitable for indoor or outdoor use. The scintillation cell 24 and the Geiger counter 28 in the particle alpha radioactivity sampler prototype were battery-powered.

The audio output signal of the Geiger counter 28 was logged using an event data logger 40, such as a HOBO model UX90-001M data logger from Onset Corp., Bourne, Massachusetts, USA, though a different data logger can be used if a higher detection frequency limit (i.e., greater than one event per second). Sample flow was provided using the vacuum pump 12 and adjusted with the metering valve 18. Flows were measured using a calibrated rotameter when logged data were downloaded.

The particle alpha radioactivity was tested indoors (i.e., an upstairs main living area and a basement) and outdoors at a residential location in Framingham, Massachusetts, USA. Initial tests were conducted in the basement, where radon was characterized using short-term (72-96 hour) measurements with radon-gas liquid scintillation test vials containing a pharmaceutical-grade charcoal-silica adsorption material (from InspectUSA of Marshall, North Carolina, USA). After collection, samples were shipped to Radon Lab (Haverhill, Massachusetts, USA) for analysis. Concurrently, radon measurements using a passive electret radon sampling unit (e.g., an E-PERM system from Rad Elec Inc., Frederick, Maryland, USA). After initial testing with the particle alpha radioactivity sampler 10, measurements were made with one particle alpha radioactivity sampler 10 in (and with its inlet tube 20 drawing air from) the basement and the other in (and with its inlet tube drawing air from) the main living area upstairs over the course of a few weeks. Subsequently, one of the particle alpha radioactivity samplers 10 was set up to measure outdoors in a well-ventilated shelter while the other remained indoors and was used for sampling the indoor air.

### Results and Discussion:

After installing a fresh filter and turning on the power, the particle alpha radioactivity sampler 10 takes approximately two hours to warm up and equilibrate to ambient particle alpha activity concentrations.

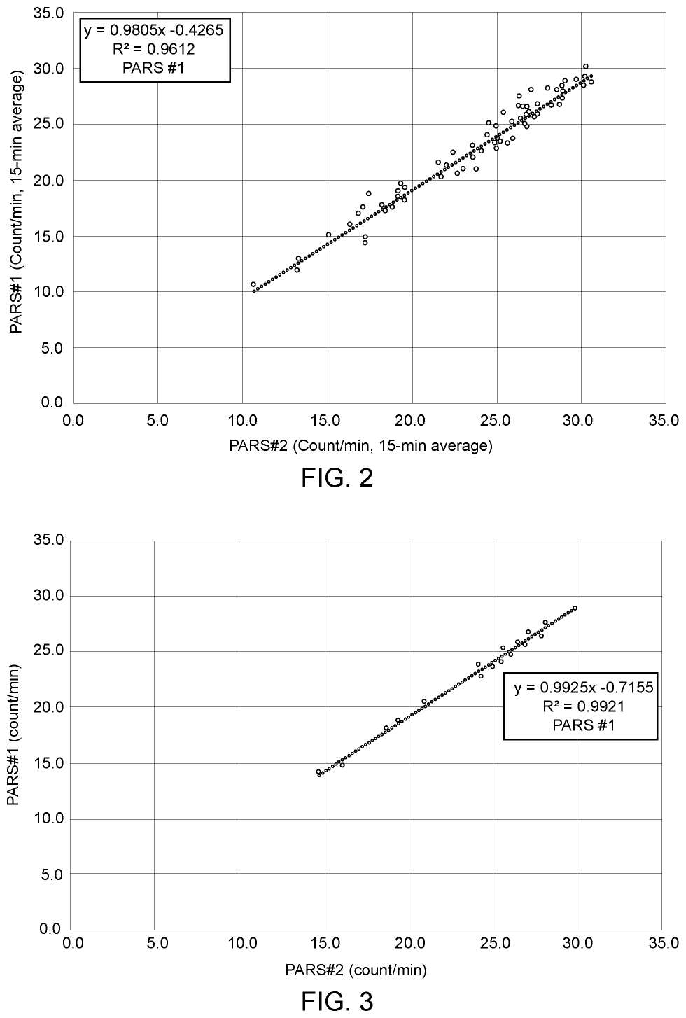

The two prototype particle alpha radioactivity samplers 10 built and used during this study showed excellent agreement during collocated operation (FIGS. 2 and 3). The particle alpha radioactivity samplers 10 were collocated in a basement location where the Radon levels averaged 308+/−71 Bq/m³. The correlation between the two particle alpha radioactivity samplers 10 was very good at a time resolution of 15 minutes (FIG. 2) and excellent at a time resolution of 60 minutes (FIG. 3). The root-mean-square errors (RMSEs) for 15- and 60-minute measurements were 0.7 and 0.6 counts/minute, respectively.

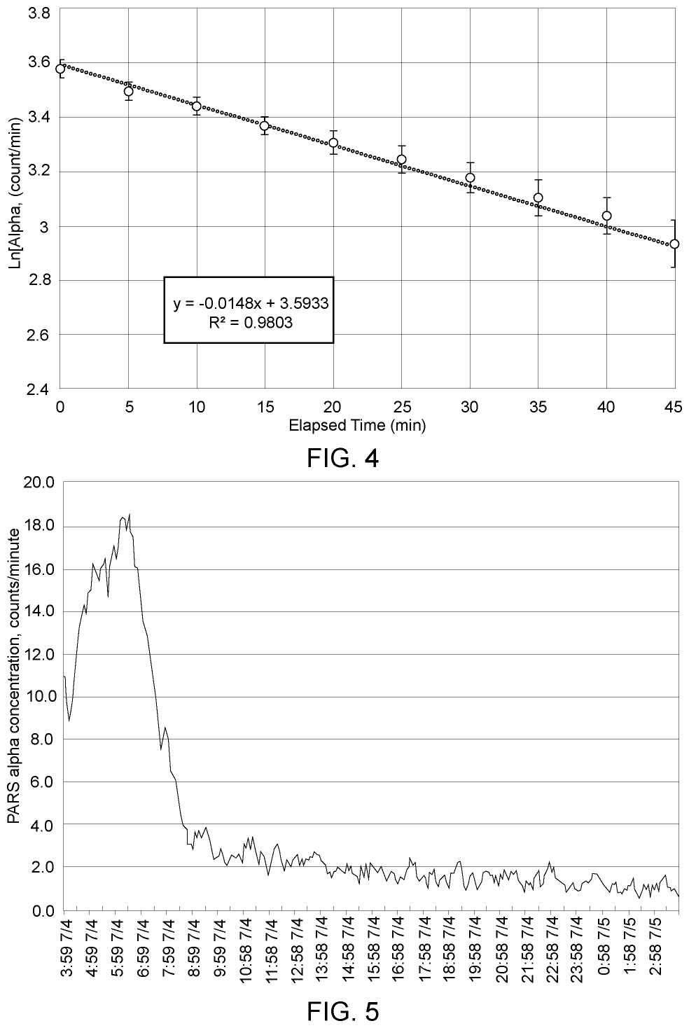

We used the particle alpha radioactivity sampler(s) 10 to estimate the decay rate of indoor short-lived alpha-emitting radionuclides (SLA). A mechanical timer was used to turn off the vacuum pump 12 for one hour, repeatedly, at different intervals while the detector measured continuously. Results for a four-hour cycle are shown in FIGS. 4-6.

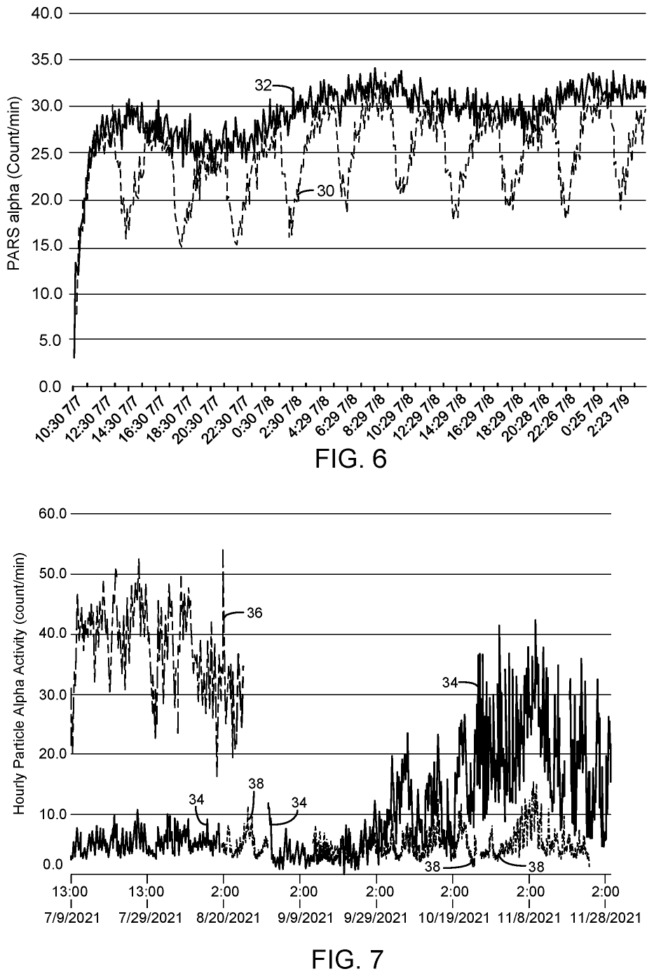

The decay rate measured by the particle alpha radioactivity sampler for the air samples, determined by regressing the ln(alpha) on elapsed time, was k=0.0148+/−0.0007 min⁻¹, which corresponds to an average half-life of 46.7 minutes [95% confidence interval, 46.2-51.8 min] (FIG. 4). Because the Geiger counter 28 and scintillation cell 24 were battery powered, alpha concentrations were also measured during a prolonged power outage (power out and pump off starting 6:55 am on July 4 and lasting through July 5) is shown in FIG. 5. The decay constant for the first 45 minutes of power outage was k=0.015 min⁻¹, corresponding to a half-life of 46.2 minutes. Subsequently, we collocated two prototype particle alpha radioactivity samplers 10, one measuring continuously and the other with the vacuum pump 12 cycling off for one hour, out of every 4 hours (FIG. 6).

This plot shows both the relatively rapid decay of short-lived alpha-emitting radionuclides (SLA) on the particulate filter 14 of the particle alpha radioactivity sampler 10 and rapid stabilization of measurement after power is turned back on, as evidenced by the agreement between the collocated particle alpha radioactivity sampler 10 in the hour prior to the repeated pump shut off in FIG. 6. Over the relatively short time resolution of measurements, this result indicates that it does not seem necessary to use a correction factor to account for decay from previously collected short-lived alpha-emitting radionuclides (SLA).

Additionally, the decay rate of particle alpha activity collected indoors and outdoors is similar, indicating that the particle alpha radioactivity measurement outdoors is also dominated by SLA.

Hourly SLA activity measurements conducted indoors (upstairs 34 and basement 36) and outdoors 38 are shown in FIG. 7 and summarized in Table 1, below. Over the course of a few weeks, measurements were made with one device in the basement 36 and the other upstairs 34. One of the particle alpha radioactivity samplers 10 was set up to measure outdoors in a well-ventilated shelter while the other remained indoors.

TABLE 1
Daily average of SLA in basement,
upstairs, and outside, by month:

| | | # | Average | SD | min | max |
|---|---|---|---|---|---|---|
| MONTH | Location | days | CPS/m³ | CPS/m³ | CPS/m³ | CPS/m³ |
| July | Basement | 22 | 225.4 | 27.4 | 159.7 | 262.0 |
| | Outside | | | | | |
| | Upstairs | 22 | 28.7 | 6.0 | 18.9 | 39.8 |
| August | Basement | 23 | 195.1 | 32.6 | 136.1 | 254.0 |
| | Outside | 12 | 27.7 | 8.5 | 18.0 | 42.8 |
| | Upstairs | 18 | 33.2 | 8.9 | 24.3 | 63.6 |
| September | Basement | | | | | |
| | Outside | 19 | 22.1 | 8.0 | 0.0 | 31.0 |
| | Upstairs | 30 | 20.2 | 8.5 | 10.0 | 44.0 |
| October | Basement | | | | | |
| | Outside | 23 | 32.1 | 12.0 | 16.8 | 65.0 |
| | Upstairs | 29 | 114.0 | 39.0 | 45.8 | 181.5 |
| November | Basement | | | | | |
| | Outside | 30 | 25.8 | 8.6 | 15.0 | 44.4 |
| | Upstairs | 31 | 79.4 | 34.3 | 28.6 | 153.8 |

In the main living area upstairs 34, the SLA daily average activity was lower in the warm months (July-September) and higher in the colder months (October-November), while the outdoor SLA daily average activity was relatively stable. Given that the outdoor concentration of radon is typically very low [with an average of 15 Becquerels per cubic meter (Bq/m³)], the outdoor SLA activity was higher than expected, averaging 27.1+/−12.2 counts per second per cubic meter (CPS/m³) over the period measured, with shorter term averages shown in Table 1.

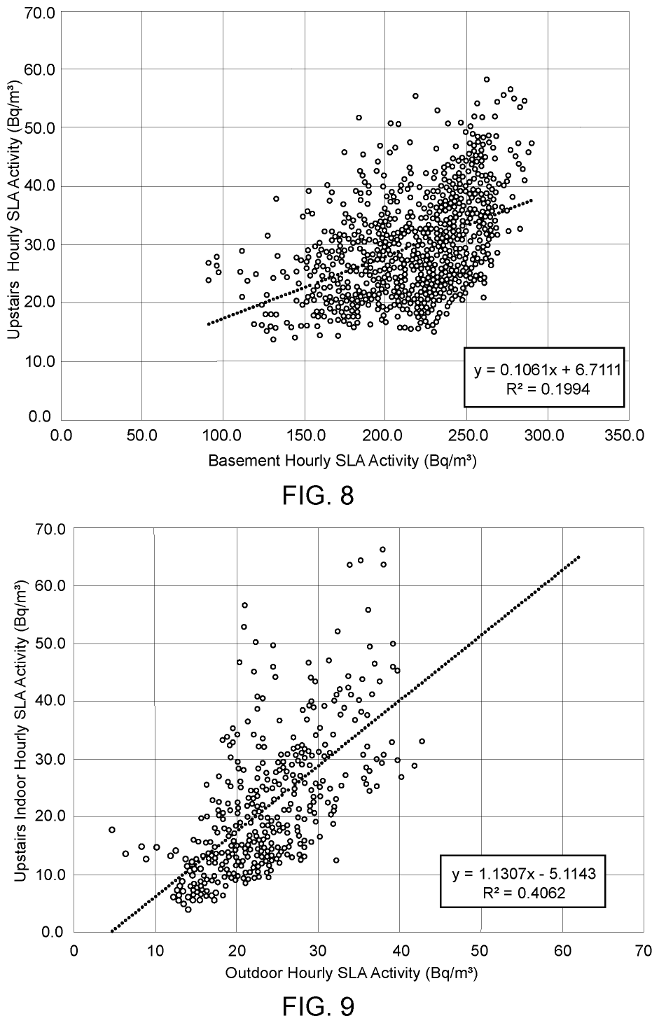

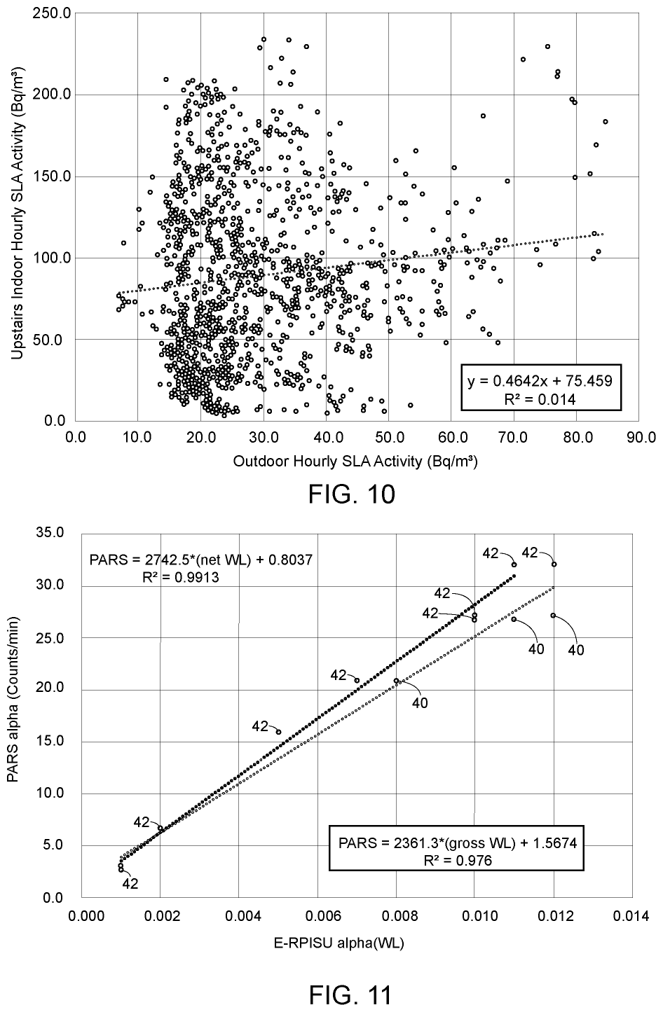

Measurements made during the summer while the house was naturally ventilated show that there was a significant but not very strong relationship between the hourly SLA activity in the basement 36 and upstairs 34 in the main living area during the summer (FIG. 8). In addition, we found that SLA activity outdoors 38 contributed significantly to SLA activity upstairs 34 during the summer measurement period but did not during the autumn (FIGS. 9 and 10). There was no relationship between SLA activity outdoors 38 and in the basement 36.

To validate the measurements of the particle alpha radioactivity sampler 10, we collocated the particle alpha radioactivity sampler 10 with a commercially available electret-radon progeny integrating sampling unit (e.g., an E-RPISU radon progeny monitor from Rad Elec Inc., Frederick, MD). The E-RPISU was used to measure a 2-10-day time-weighted average of particle alpha activity, which was compared with the average concentrations measured by the particle alpha radioactivity sampler over the same period. Measurements with both the particle alpha radioactivity sampler 10 and the E-RPISU were made both in the basement and upstairs (windows open and closed) to achieve a range of concentrations. Results from the comparison are shown in FIG. 11 [with plots for the gross working limit (WL) 40 and for the net working limit (WL) 42] and indicate very good agreement between the two different methods, with an R² of 0.99.

We evaluated the impact of radon on the alpha activity measurement from the particle alpha radioactivity sampler (PARS) 10 by conducting measurements using two prototype PARS 10 with fresh particulate filters 14 side-by-side, where one of the PARS 10 was equipped with a high-efficiency inline filter attached to its inlet 20 to sample indoor air without collecting particulate matter on the particulate filter 14. Experiments were conducted on two different days; and results from the experiment are presented in Table 2, below. Hourly radon concentrations during the experiments were measured using a RAD7 radon monitor (from Durridge Inc., Billerica MA) and averaged 222.6+/−76.0 Bq/m³. Across both experiment days, the PARS 10 measured the particle alpha activity to be 160.3+/−53.5 CPS/m³, while the PARS sampling filtered air only measured 7.4+/−3.0 CPS/m³. On average, the filtered PARS measurement was 4.6+/−0.8% of the unfiltered PARS and 3.4+/−0.8% of the radon concentration. A third test, conducted outdoors with a radon concentration of 22 Bq/m³, found that the unfiltered PARS measured 41.4+/−12.0 CPS/m³, while the filtered PARS measured only 1.1+/−0.4 CPS/m³. We find that continuous measurement using PARS does not need to be corrected for alpha activity from the decay of radon due to the very small chamber volume, short residence time, and short measurement interval.

TABLE 2
Effect of radon on PARS alpha activity measurement:

| | Measurement | Average | SD | Minimum | Maximum |
|---|---|---|---|---|---|
| | (hourly) | (CPS/m³) | (CPS/m³) | (CPS/m³) | (CPS/m³) |
| TEST | PARS SLA | 129.4 | 40.0 | 63.3 | 170.5 |
| 1 | PARS, Filtered | 5.9 | 2.1 | 2.5 | 8.8 |
| | air only | | | | |
| | RADON | 197.7 | 83.5 | 74.0 | 314.5 |
| | Concentration | | | | |
| TEST | PARS SLA | 189.9 | 48.3 | 120.2 | 252.5 |
| 2 | PARS, Filtered | 8.8 | 3.0 | 4.0 | 13.9 |
| | air only | | | | |
| | RADON | 246.5 | 60.6 | 162.8 | 347.8 |
| | Concentration | | | | |
| TEST | PARS SLA | 41.4 | 12.0 | 28.9 | 69.1 |
| 3 | PARS, Filtered | 1.1 | 0.4 | 0.3 | 1.8 |
| | air only | | | | |
| | RADON | 21.9 | 9.3 | 3.3 | 45.5 |
| | Concentration | | | | |

### Conclusion:

Disclosed herein is a reliable and inexpensive particle alpha radioactivity sampler (PARS). PARS provides time-resolved measurement (15-60 min) of particle gross alpha activity, including short-lived alpha-emitting radionuclides (SLA), at environmentally relevant concentrations both indoors and outdoors. Collocated PARS have been shown to have excellent precision during measurement periods of 15-60 min. This device is suitable for use in exposure assessment or indoor/outdoor air chemistry studies and can be used to investigate the complex relationship between radon and its decay products and ambient particles.

In describing embodiments herein, specific terminology is used for the sake of clarity. For the purpose of description, specific terms are intended to at least include technical and functional equivalents that operate in a similar manner to accomplish a similar result. Additionally, in some instances where a particular embodiment includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments, those parameters or values can be adjusted up or down by 1/100^{th}, 1/50^{th}, 1/20^{th}, 1/10^{th}, 1/5^{th}, 1/3^{rd}, 1/2, 2/3^{rd}, 3/4^{th}, 4/5^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof or within a range of the specified parameter up to or down to any of the variations specified above (e.g., for a specified parameter of 100 and a variation of 1/100^{th}, the value of the parameter may be in a range from 0.99 to 1.01), unless otherwise specified. Further still, where methods are recited and where steps/stages are recited in a particular order—with or without sequenced prefacing characters added for ease of reference—the steps/stages are not to be interpreted as being temporally limited to the order in which they are recited unless otherwise specified or implied by the terms and phrasing.

Additional examples consistent with the present teachings are set out in the following numbered clauses:
1. A particle alpha radiation sampler, comprising:
   a scintillation cell;
   a Geiger counter in electrical communication with the scintillation cell and configured to measure incidence of particle alpha radiation on the scintillation cell;
   a vessel defining a chamber, wherein the scintillation cell is configured to receive alpha radiation passing through air in the chamber from particulate matter collected on a filter;
   at least one inertial impactor in fluid communication with the chamber and configured to allow passage of particles only at or below an established size threshold into the chamber;
   the filter, wherein the filter is in fluid communication with the chamber, and wherein the filter is configured to collect particulate matter from the air in the chamber drawn through the inertial impactor; and
   a vacuum pump in fluid communication with the chamber and configured to draw air flow through the filter from the chamber and to draw air flow through the inertial impactor into the chamber.
2. The particle alpha radiation sampler of clause 1, wherein the inertial impactor is configured to only allow passage of particulate matter with dimensions no greater than 2.5 μm into the chamber.
3. The particle alpha radiation sampler of clauses 1 or 2, wherein the Geiger counter is configured to measure the incidence of particle alpha radiation by generating an audio output signal.
4. The particle alpha radiation sampler of clause 3, further comprising an event data logger configured to capture the audio output signal from the Geiger counter and to store the history of captured audio output signals.
5. The particle alpha radiation sampler of any of clauses 1-4, further comprising a flow meter configured to measure the air flow into the chamber.
6. The particle alpha radiation sampler of any of clauses 1-5, further comprising a film between the chamber and the scintillation cell, wherein the film allows passage of particle alpha radiation through the film while blocking passage of other particles.
7. A method for particle alpha radiation sampling, comprising:
   using a vacuum pump, drawing air out of a chamber defined by a vessel and drawing air samples through at least one inertial impactor into the chamber and through a filter, wherein the inertial impactor removes particulate matter sized above an established size threshold and the filter collects the particulate matter sized below the established size threshold of the inertial impactor;
   recording incidence of particle alpha radiation on a scintillation cell, wherein the particle alpha radiation (i) is emitted by radionuclides contained in the particle matter collected on the filter and (ii) travels through the chamber and through a window to a scintillation cell;
   transmitting a signal from the scintillation cell to a Geiger counter with each incidence of particle alpha radiation on the scintillation cell; and
   using the Geiger counter to measure the incidence of the particle alpha radiation on the scintillation cell.
8. The method of clause 7, further comprising determining a decay rate of the short-lived alpha-emitting radionuclides from the measured incidence of the particle alpha radiation on the scintillation cell.
9. The method of clause 7 or 8, wherein the short-lived alpha-emitting radionuclides comprise radon decay progeny.
10. The method of any of clauses 7-9, further comprising measuring a flow rate of the air into the chamber.
11. The method of any of clauses 7-10, wherein the inertial impactor only allows passage of particulate matter with dimensions no greater than 2.5 μm into the chamber.
12. The method of any of clauses 7-11, wherein the Geiger counter measures the incidence of particle alpha radiation by generating an audio output signal.
13. The method of any of clauses 7-12, further comprising using an event data logger to capture the audio output signal from the Geiger counter and to store the history of captured audio output signals.
14. The method of any of clauses 7-13, further comprising using a flow meter to measure air flow into the chamber.
15. The method of any of clauses 7-14, wherein the particle alpha radiation sampler further comprises a film between the chamber and the scintillation cell, wherein the film allows passage of alpha radiation through the film while blocking passage of other particles.

While this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety for all purposes; and all appropriate combinations of embodiments, features, characterizations, and methods from these references and the present disclosure may be included in embodiments of this invention. Still further, the components and steps identified in the Background section are integral to this disclosure and can be used in conjunction with or substituted for components and steps described elsewhere in the disclosure within the scope of the invention.

What is claimed is:

1. A particle alpha radiation sampler, comprising:
a scintillation cell;
a Geiger counter in electrical communication with the scintillation cell and configured to measure incidence of particle alpha radiation on the scintillation cell;
a vessel defining a chamber, wherein the scintillation cell is configured to receive alpha radiation passing through air in the chamber from particulate matter collected on a filter;
at least one inertial impactor in fluid communication with the chamber and configured to allow passage of particles only at or below an established size threshold into the chamber;
the filter, wherein the filter is in fluid communication with the chamber, and wherein the filter is configured to collect particulate matter from the air in the chamber drawn through the inertial impactor; and
a vacuum pump in fluid communication with the chamber and configured to draw air flow through the filter from the chamber and to draw air flow through the inertial impactor into the chamber.

2. The particle alpha radiation sampler of claim 1, wherein the inertial impactor is configured to only allow passage of particulate matter with dimensions no greater than 2.5 μm into the chamber.

3. The particle alpha radiation sampler of claim 1, wherein the Geiger counter is configured to measure the incidence of particle alpha radiation by generating an audio output signal.

4. The particle alpha radiation sampler of claim 3, further comprising an event data logger configured to capture the audio output signal from the Geiger counter and to store the history of captured audio output signals.

5. The particle alpha radiation sampler of claim 1, further comprising a flow meter configured to measure air flow into the chamber.

6. The particle alpha radiation sampler of claim 1, further comprising a film between the chamber and the scintillation cell, wherein the film allows passage of particle alpha radiation through the film while blocking passage of other particles.

7. A method for particle alpha radiation sampling, comprising:
using a vacuum pump, drawing air out of a chamber defined by a vessel and drawing air samples through at least one inertial impactor into the chamber and through a filter, wherein the inertial impactor removes particulate matter sized above an established size threshold and the filter collects the particulate matter sized below the established size threshold of the inertial impactor;
recording incidence of particle alpha radiation on a scintillation cell, wherein the particle alpha radiation (i) is emitted by radionuclides contained in the particulate matter collected on the filter and (ii) travels through the chamber and through a window to a scintillation cell;
transmitting a signal from the scintillation cell to a Geiger counter with each incidence of particle alpha radiation on the scintillation cell; and
using the Geiger counter to measure the incidence of the particle alpha radiation on the scintillation cell.

8. The method of claim 7, further comprising determining a decay rate of the alpha-emitting radionuclides from the measured incidence of the particle alpha radiation on the scintillation cell.

9. The method of claim 7, wherein the short-lived alpha-emitting radionuclides comprise radon decay progeny.

10. The method of claim 7, further comprising measuring a flow rate of the air into the chamber.

11. The method of claim 7, wherein the inertial impactor only allows passage of particulate matter with dimensions no greater than 2.5 μm into the chamber.

12. The method of claim 7, wherein the Geiger counter measures the incidence of particle alpha radiation by generating an audio output signal.

13. The method of claim 12, further comprising using an event data logger to capture the audio output signal from the Geiger counter and to store the history of captured audio output signals.

14. The method of claim 7, further comprising using a flow meter to measure air flow into the chamber.

15. The method of claim 7, wherein the particle alpha radiation sampler further comprises a film between the chamber and the scintillation cell, wherein the film allows passage of particle alpha radiation through the film while blocking passage of other particles.
